(19) United States
(12) Patent Application Publication
(10) Pub. No.: US 2003/0235761 A1
(43) Pub. Date: Dec. 25, 2003

(54) Rechargeable lithium-containing battery employing brannerite type LiVMoO5.5 cathode and method of preparing same

(76) Inventor: S.R. Sahaya Prabaharan, Selangor Darul Ehsan (MY)

Correspondence Address: FINNEGAN, HENDERSON, FARABOW, GARRETT & DUNNER, LLP, 1300 I STREET, NW, WASHINGTON, DC, 20005, US

(21) Appl. No.: 10/422,837

(22) Filed: Apr. 25, 2003

(30) Foreign Application Priority Data
Apr. 26, 2002 (MY) PI 20021559

(51) Int. Cl. H01M 4/48; C01G 31/02

(52) U.S. Cl. 429/231.2; 429/231.5; 423/594.8

(57) ABSTRACT

The present invention is to provide a non-aqueous electrolyte secondary cell and/or battery, which use a brannerite type lithium vanadium molybdenum oxide, LiVMoO_{5.5}. The material synthesized following a simple aqueous solution reaction (ASR) process exhibits both submicronic and nanophase particles having low porosity, demonstrates the high voltage behavior in lithium-containing cells and battery. The present invention also provides a method for producing the above mentioned cathode-active material in bulk quantity by means of ASR process, called sol-gel, xerogel, co-precipitation, hydrothermal, glycine-nitrate soft-combustion process, precursor complexation process (all kinds of carboxylic acid as complexation agents as well as alkoxides). In particular, the method comprises preparing a lithium vanadium molybdenum oxide with brannerite structure (layered) and having molecular formula LiVMoO_{5.5}. This invention also demonstrates that LiVMoO₆ regarded as parent oxide could be tailored into high voltage class (4V type) cathode material by means of anion engineering.

### BACKGROUND OF THE INVENTION

(A) Field of invention

This present invention relates to a Lithium-containing battery and in particularly, to rechargeable lithium-containing battery employing Brannerite type LiVMoO_{5.5} cathode. The present invention also relates to a method of preparing rechargeable Lithium-Containing battery.

(B) Brief Description of the Prior Art

Apparently, the present day commercial lithium-ion and lithium/polymer rechargeable cells contain the conventional cathode-active materials such as layered-LiCoO₂ and spinel-LiMn₂O₄. The latter has poor rate capability and suffering from Jahn Teller distortion below 3V-region and cell deterioration is rapid below 3V-region. However, the former, though expensive, has been reportedly performing better in practical Li-Ion cells but the toxic cobalt does pose environmental unfriendliness.

A large number of vanadium compounds have been studied in a search for new high voltage cathode materials for advanced lithium-containing rechargeable batteries. Hither to, LiVMoO₆ has been thought of as a cathode in low voltage class rechargeable lithium batteries with working voltage lower than 3V, since the transition metals present in the oxide, namely, V and Mo, are in their highest valence state, 5+ and 6+ respectively and so lithium deintercalation supposedly results in further oxidation of the metals which occurs unlikely and hence makes the oxide unsuitable for high voltage class positive electrodes. However, more than two lithium per formula unit can be topotactically intercalated/deintercalated from this oxide lattice in the voltage range of 3.0V-1.5V thus results in practical capacity greater than 200mAh/g due to the easy reduction of V and Mo to their lower oxidation states. The above have been disclosed in J. B Goodenough et al., Denki Kagaku, 66(1173) 1998, and S. R. S. Prabaharan, M. S. Michael, Abstracts of Mater Res. Soc. Symp. Fall meeting 1998 (Boston); number EE3.26.

Brannerite-type LiVMoO₆ was first synthesized by Galy et al., refer to J. Galy, J. Darriet and B. Darriet, C. R. Acad. Sci. Paris, 264 (1477) 1967, and J. Galy, G. Meunier, J.senegas and P. Hagenmuller, J. Inorg Nucl. Chem., 33 (2403) 1971. LiVMoO₆ crystallizes in brannerite (ThTi₂O₆) structure of AB₂O₆ (OAOBOBOAOBOB) type, having a general formula LiM′₂O₆ (M′=transition metals) with lattice parameters, a=9.347 Å, b=3.670 Å, c=6.632 Å, β=111°28′ for LiVMoO₆.

The structure of LiVMoO_{5.5} is topologically similar to the structure of LiVMoO₆ except the unshared oxygen of the MoO₆ octahedra in the adjacent layers which are connected to form quasi-two dimensional structure in the former while in the latter, only one of the oxygen atoms of each MoO₆ octahedra is unshared and thus forming a brannerite structure as depicted in FIG. 1, referring to J. Gopalakrishnan, N. S. P Bhuvanesh, R Vijayaraghavan and N. Y. Vasanthacharya, J. Mater. Chem., 7(2) (307) 1997, M. S. Michael, Ahmad Fauzi, S. R. S. Prabaharan, Inter, J. Inorg. Mater., 2 (2000) 276.

LiVMoO_{5.5} crystallizes in the monoclinic system, space group P2/m, with the unit-cell dimensions a=9.25539, b=3.64711, c=6.63521 Å, β=110.19°. The unit cell parameters are derived by least-squares refinement of the powder diffraction data using WINPLOTER program. This invention relates to a process by which the oxygen stoichiometry of lithium vanadium molybdate, LiVMoO₆, which is known to perform as a low voltage cathode (3V class), to be converted into a high voltage class (4V class type) electrode material upon altering the oxygen stoichiometry by means of anion engineering technique which leads to changing the valence structure of the transition metals cations namely vanadium (V⁵⁺) and molybdenum (Mo⁵⁺) and behaves as cathode (positive electrode) in actual test cells against lithium in conjunction with solid polymer electrolytes and therefore, this material is found to be excellent for polymer electrolyte based lithium rechargeable cells. It also describes the use of this material in Li-Ion cells as well. This invention also relates to the preparation of bulk quantities of homogeneous LiVMoO_{5.5} sub-micron scale and/or nanoscale powders using a single step approach known as soft-combustion method whereby aqueous glycine (amino acetic acid) is used as soft combustion agent at a low temperature. This invention exclusively covers the preparation of stiochiometric product of the above compound by employing other solution-based approaches such as complexation, xerogel and sol-gel techniques. Also, it covers the preparation of LiVMoO₆ using the above approach and tested against lithium metal as both reference and counter electrode in order to test their electrode active nature.

This invention explains the anion engineering by which the synthesis of lithiated transition metal oxide product, LiVMoO_{5.5} whose oxygen stoichiometry/oxidation state of transition-metal atoms was determined by redox potentiometric titration using Ce⁴⁺ as the oxidant. The oxide, LiVMoO_{5.5}, is of interest as 0.8 lithium per formula unit can be reversibly removed/inserted during the charge/discharge process at 4.7 V vs Li+/Li during first cycle. The reaction scheme below describes the first charge situation starting from the OCV of the cell against lithium which is 3.7 V :

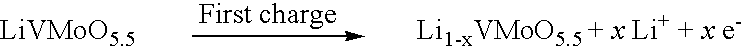

The above reaction is electrochemically proven as shown in FIG. 7 During the first discharge, the cathode material is able insert a maximum of 1.5 Li per formula in the voltage range 4.7-2.8 V as shown in FIG. 7.

The basis of this invention lies based on a logically quest that if the oxidation state of any one of the transition metals of the parent oxide, LiVMoO₆, could be altered, i.e., reduced by chemical means without affecting its host structure, the oxide would be promoted to the higher voltage (3-4V) category of cathode materials for lithium-containing batteries. It has been confirmed that upon altering the oxygen stoichiometry of the parent compound, LiVMoO₆, as it retains its layered structure over the compositional regime: LiVMoO₆ to LiVMoO_{6-δ} (0<δ<1), the parent oxide, LiVMoO₆ is promoted to high voltage category as the present invention exemplifies the possibilities as summarized.

Normally, oxides are synthesized by a solid-state reaction at high temperature, involving repetition of steps like mixing, annealing, etc. and it takes a long time to complete the wholesome process. Besides, it is very difficult to control the homogeneity and particle size of the synthesized powders since the contact between reactants is only in particle level. On the other hand, in the solution technique, molecular level mixing is evident and hence it allows the control of particle size and homogeneity of the oxides. It is also a single step process and the reaction ceases within a few hours. When considering the capacity and reversibility of the cell containing these oxides as energy storage materials, the so called electrodes (in this case as cathode), the homogeneity and morphology of materials play a vital role in order to achieve a high percentage of efficiency as the cells are electrochemically cycled for a number of times (Cycle life).

According to various patent database, LiVMoO_{5.5} as a cathode in high voltage lithium-containing batteries has never been tried and so its synthesis by lower temperature methods which include sol-gel, xerogel, co-precipitation, hydrothermal, soft-combustion and precursor complexation methods (all kinds of carboxylic acid complexation and alkoxides) and also, solid state reaction.

U.S. Pat. No. 4,710,439 issued Assignee, Bell Communications Research, Inc. discloses secondary lithium battery, wherein LixMo₂O₄ is used.

U.S. Pat. No. 5,910,382 discloses a secondary alkali-ion battery, wherein transition-metal compounds having the ordered olivine or the rhombohedra structure and containing the polyanion as at least one constituent for use as electrode material for alkali-ion rechargeable batteries is used.

### OBJECT AND SUMMARY OF INVENTION

It is therefore the object of the present invention to provide rechargeable Lithium-containing battery employing Brannerite type LiVMoO_{5.5}, wherein a parent oxide whose stoichiometric formula is given by LiVMoO₆, is employed, that is, the oxygen stoichiometry of it is altered by changing the valence state of any one of the transition metals; in this case either Vanadium (V) or Molybdenum (Mo), to make it suitable for high voltage cathode material for lithium-ion and/or lithium metal anode rechargeable batteries and its synthesis by a simple, inexpensive solution method for bulk synthesis with controlled morphology and particle size. Oxygen flow and temperature of annealing are optimized to get the oxide of desired composition LiVMoO_{5.5}.

Yet another object of the present invention is to provide a method of preparing rechargeable Lithium-containing battery employing Brannite Type LiVMoO_{5.5}. In accordance with this invention, there is provided a process for preparing fine powders (both nano and micron sized) possessing a single phase, LiVMoO_{5.5} comprising the steps of mixing salt mixtures of lithium nitrate, ammonium vanadate and ammonium molybdate in water, adding aqueous solution of fuel, adjusting the pH of the solution to less acidic or neutral, evaporating water to get a homogenous paste compound, decomposing the paste at low temperature, below 400° C. to obtain an oxide phase, and annealing at controlled oxygen atmosphere at 600° C. to obtain the desired oxide composition.

An aspect of the present invention is to provide a non-aqueous rechargeable Lithium-containing battery including a brannerite type lithium vanadium molybdenum oxide, characterized in that a low voltage oxide, LiVMoO₆ is promoted to high voltage family of cathode materials for the lithium-ion batteries by altering the oxygen stoichiometry to obtain the oxide of composition of LiVMoO_{5.5.}

This invention will be clearly understood and apparent with reference to the accompanying drawings and detailed description, which follow.

### BRIEF DESCRIPTION OF THE DRAWINGS

This invention may be better understood and its numerous objects and advantages will become apparent to those skilled in the art by reference to the accompanying drawings and photographs as follows:

FIG. 1 shows a polyhedral view of brannerite structure disclosed in example 1, 2 and 3 in accordance with the present invention.

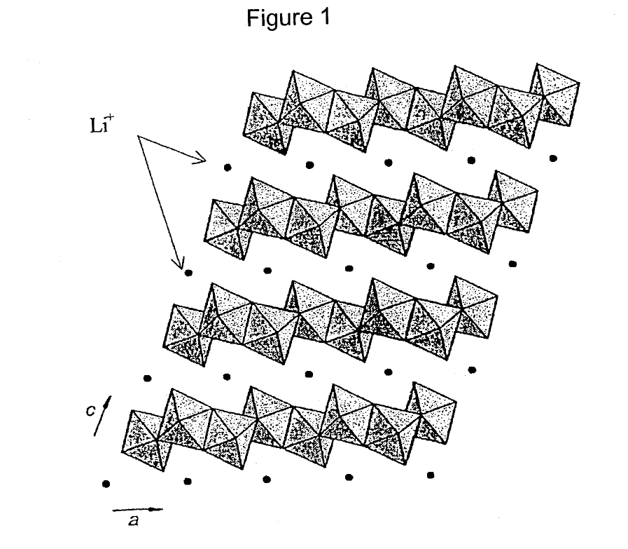

FIG. 2 is a flowchart describing the synthesizing process disclosed in example 1 and 2 in accordance with the present invention.

FIG. 3 shows a DTA/TG thermograms of precursor product described in example 1, 2, and in accordance with the present invention.

FIGS. 4A and 4B are the indexed X-ray powder diffraction patterns of brannerite LiVMoO_{5.5} prepared from examples 1 and 2 respectively in accordance with the present invention.

FIG. 5 shows a Rietveld profile refinement analysis for the powder XRD pattern of LiVMoO_{5.5} (example 1 & 2) in accordance with the present invention.

FIGS. 6A and 6B are scanning electron microscopic photographs showing submicron and nanophase particles of the product described in example 1 and 2 respectively in accordance with the present invention.

FIG. 7 shows the intermittent charge-discharge curves of the cathode material against Li⁺/Li at 0.05 mA/cm² (0.25 mA/g) during charge and 0.025 mA/em² (discharge) of example 1 between the cell potential (voltage) and concentration of lithium atoms (x) in LiVMoO_{5.5} as described in example 1 in accordance with the present invention.

FIG. 8 is a chart showing the electrochemical cyclic performance of the product against lithium metal (counter and reference electrode) described in example 1 employing the flooded electrolyte configuration using 1M LiPF₆ (EC+DMC) (1:1 v/v) non aqueous electrolytes in accordance with the present invention.

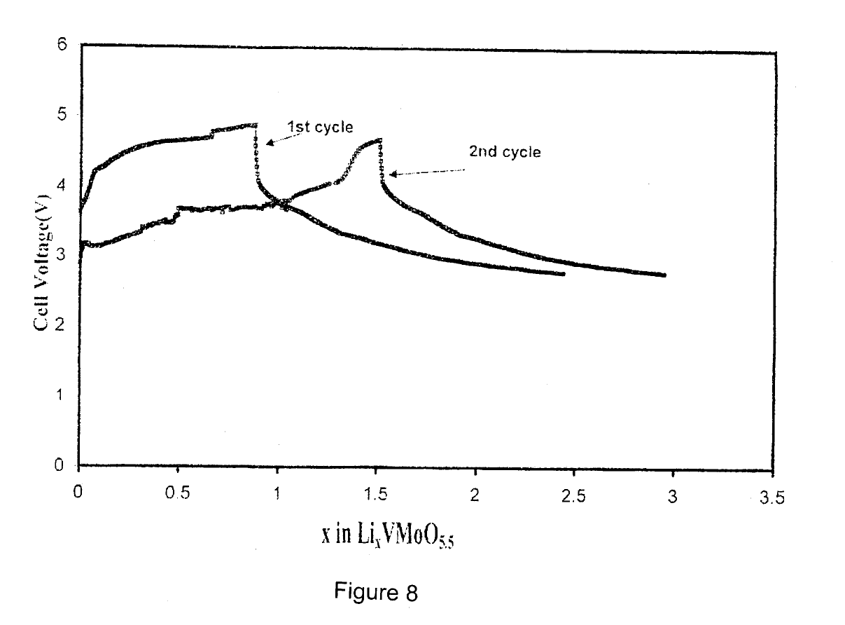

### DETAILED DESCRIPTION OF THE INVENTION

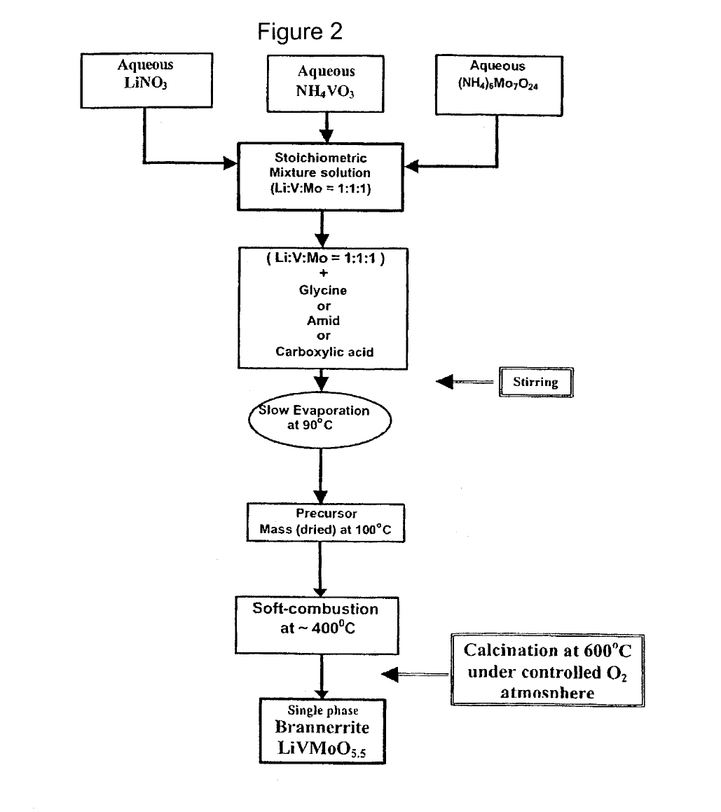

With reference now more particularly to FIG. 2, there is shown the process according to this invention, of fabricating rechargeable Lithium-containing battery employing Brannite type LiVMoO_{5.5} cathode. The process, as illustrated in FIG. 2 starts with mixing the aqueous solution of lithium nitrate, with aqueous solution of ammonium vanadate and aqueous solution of ammonium molybdate. The mixture yields a clear solution.

An aqueous solution of a fuel is then added to the above solution, and such fuel is preferably selected from one of the following and/or the combination thereof, that is amino acids—glycine or amide, urea, and carboxylic acids as chelating agent. In accordance with the present invention, the concentration of the fuel is preferably in the range of 3.0M and 5.0M.

In accordance with the present invention, the pH of the solution is adjusted with the help of HNO₃ either to less acidic or neutral side.

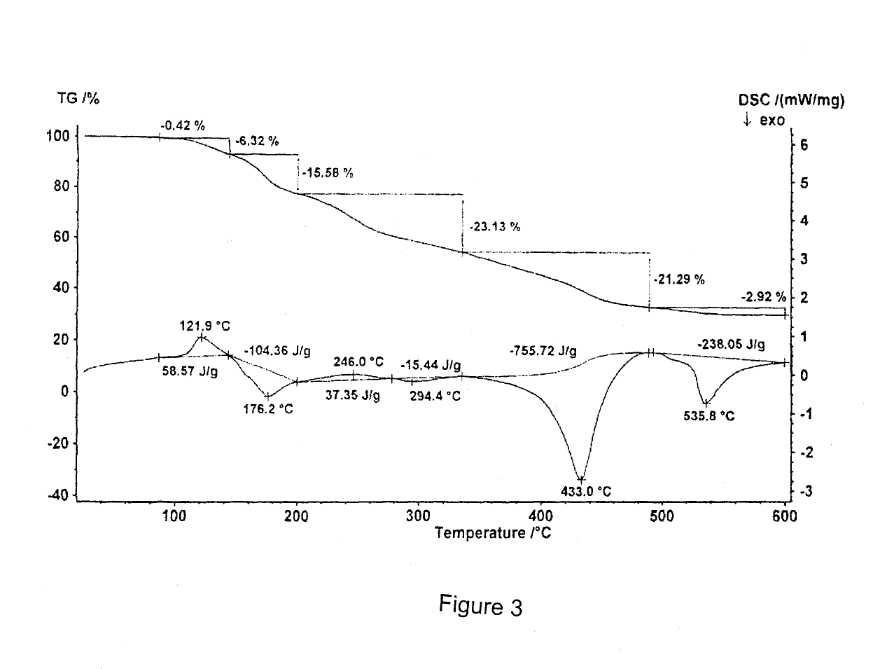

Upon slow evaporation of water at 100° C. in an open atmosphere, the mixture becomes homogeneous viscous paste like substance. This paste is gently heated at 300-400° C. for 30 minutes to decompose the paste and yield the oxide. FIG. 3 shows the thermal decomposition behavior of the dried precursor product.

The oxide is annealed at 600° C. for 4 hours in controlled oxygen atmosphere to get the compound with desired oxygen stoichiometry. The oxide has been employed as a cathode in lithium containing cells.

In a preferred embodiment of the invention, stoichiometric amounts of the lithium, vanadium and molydate salts are employed as starting materials. The resulting LiVMoO_{5.5} powders vary in grain sizes between 1 μm and 5 nm.

### EXAMPLE 1

Salts:

| | |
|---|---|
| Lithium nitrate | 0.7 g |
| Ammonium vanadate | 12.0 g |
| Ammonium Molybdate | 9.0 g |

Dissolving medium:

| | |
|---|---|
| Water (demonized water) | 200 ml |

Fuel:

| | |
|---|---|
| Glycine (NH2CH2000H) | 21.0 g |
| PH | 5.0 |

The decomposed product is annealed at 600° C. with the oxygen flow at a rate of 200 ml/min

### EXAMPLE 2

Salts:

| | |
|---|---|
| Lithium nitrate | 0.1 g |
| Ammonium vanadate | 12.0 g |
| Ammonium molybdate | 9.0 g |

Dissolving medium:

| | |
|---|---|
| Water (deionized water) | 200 ml |

Fuel

| | |
|---|---|
| Urea | 30.0 g |
| pH | 7.0 |

The decomposed product is annealed at 600° C. with the oxygen flow at a rate of 200 ml/min

### EXAMPLE 3

Salts:

| | |
|---|---|
| Lithium nitrate | 0.1 g |
| Ammonium vanadate | 12.0 g |
| Ammonium molybdate | 9.0 g |

Dissolving medium:

| | |
|---|---|
| Water (deionized water) | 200 ml |

Fuel

| | |
|---|---|
| Carboxylic acid | 30.0 g |
| pH | 7.0 |

The decomposed product is annealed at 600° C. with the oxygen flow at a rate of 200 ml/min.

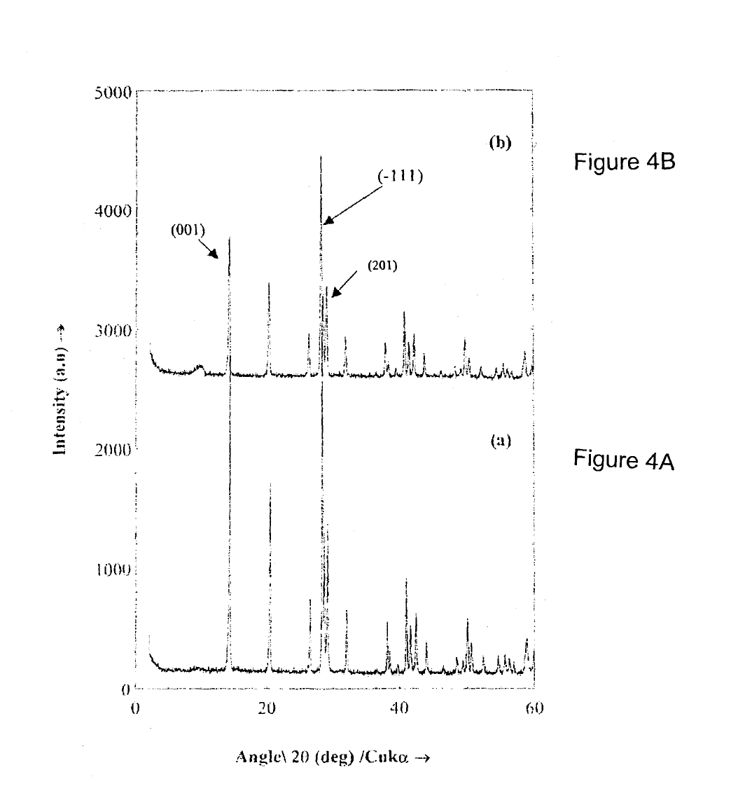

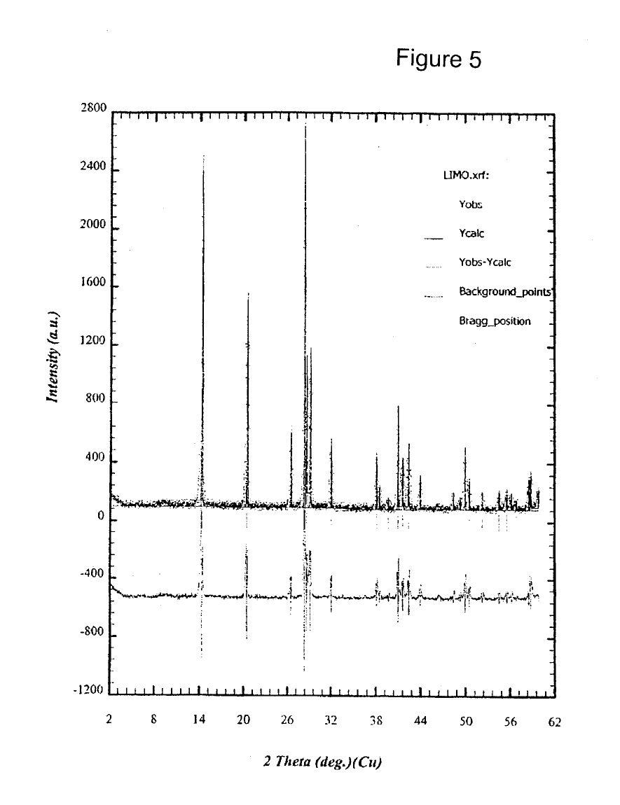

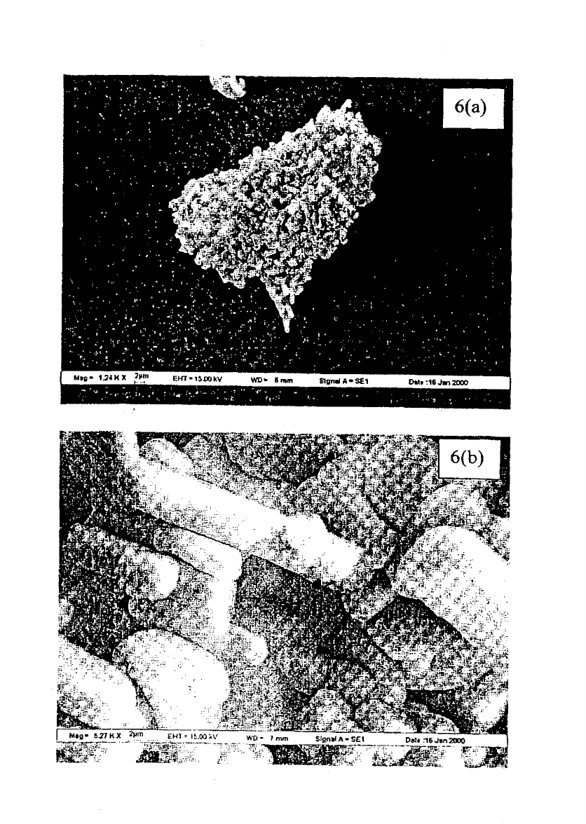

The x-ray diffraction pattern (XRD) of LiVMoO_{5.5} corresponding to Example 1 and Example 2 are as shown in FIGS. 4A and 4B respectively. The Rietveld refinement of the product described in example 1 is shown in FIG. 5. The Scanning Electron Micrograph (SEM) on the LiVMoO_{5.5} powder prepared according to the example 1 and example 2 are shown in FIGS. 6A and 6B respectively that the average diameter of the spherical particles is between 1 μm-1 nm.

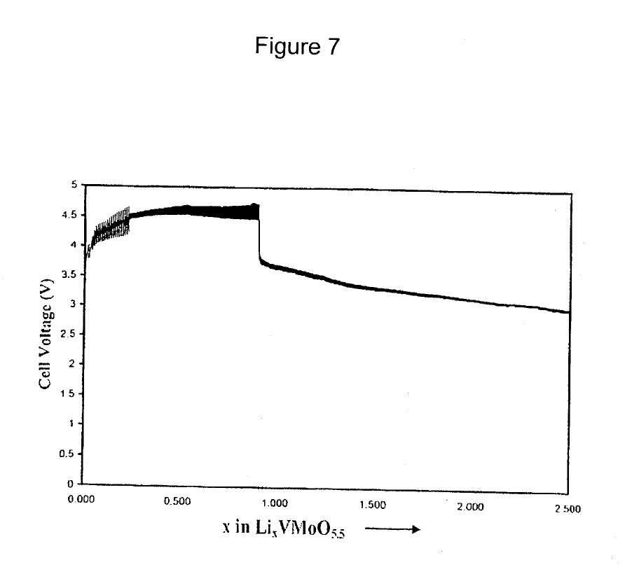

The LiVMoO_{5.5}, prepared according to this invention behaves reversibly as a cathode material when coupled with lithium metal in a coin type (2450) configuration by employing a non-aqueous electrolyte, containing Li⁺ions as shown in FIGS. 7 & 8. The material is also examined in a flat cell configuration employing PVDF-HFP co-polymer gel electrolyte membrane. It is evident from FIG. 7 that 0.8 lithium per formula unit can be extracted from this oxide and 1.5 Li⁺ can be intercalated into this oxide in the range 2.8-4.7 V. The total reversible capacity of the oxide is ˜300mAh/g down to 1.5 V while in the high voltage range it gives 150mAh/g as reversible capacity.

It is to be understood by persons skilled in the art that the physical embodiments described herein only exemplify the invention, which may be embodied in other specific structure. The scope of the invention is defined in the claims appended thereupon.

What is claimed is:

1. A non-aqueous rechargeable Lithium-containing battery including a brannerite type lithium vanadium molybdenum oxide, characterized in that a low voltage oxide, LiVMoO₆ is promoted to high voltage family of cathode materials for the lithium-ion batteries by altering the oxygen stoichiometry to obtain the oxide of composition of LiVMoO_{5.5}.

2. The non-aqueous rechargeable Lithium-containing battery of claim 1, wherein the oxide of the composition of LiVMoO_{5.5} produces ˜180 mAh/g as reversible capacity in the high voltage (2.8-4.7V) region.

3. A fabrication method for a rechargeable Lithium-containing battery comprising the steps of:
a) mixing salt mixtures of lithium nitrate, ammonium vanadate and ammonium molybdate in a deionising water;
b) adding aqueous solution of fuel to the mixtures obtained in (a);
c) adjusting the pH of the solution to less acidic or neutral;
d) evaporating water to get a homogenous sticky paste compound;
e) decomposing the paste at low temperature, below 400° C. to obtain an oxide precursor; and
f) heating under a controlled oxygen atmosphere with a flow rate (200 ml/min) at 600° C. to get the desired oxide composition.

4. The fabrication method as set forth in claim 3, wherein the said fuel is amino acetic acid, amide, carboxylic acid or alkoxide.

5. The fabrication method as set forth in claims 3 or 4, wherein the pH of the solution is adjusted to 5-7.

6. The fabrication method as set forth in any of claims 3-5, wherein the decomposed product is annealed at 600° C. under controlled oxygen pressure 200 ml/min to obtain the resultant oxide.

7. The fabrication method as set forth in any of claims 3-6, wherein the particle size of resultant powders is in micron to nanoscale level.
